(19) United States
(12) Patent Application Publication
(10) Pub. No.: US 2015/0006514 A1
(43) Pub. Date: Jan. 1, 2015

(54) Method and Computer System for Searching Intended Path

(71) Applicant: Jiun Hung, Hsinchu City (TW)

(72) Inventor: Jiun Hung, Hsinchu City (TW)

(21) Appl. No.: 14/314,007

(22) Filed: Jun. 24, 2014

Related U.S. Application Data
(60) Provisional application No. 61/840,473, filed on Jun. 28, 2013.

(51) Int. Cl. G06F 17/30

(52) U.S. Cl. CPC G06F 17/30424
USPC 707/722

(57) ABSTRACT

A method for searching an intended path among user mental models comprises retrieving a plurality of mental models from a plurality of users; receiving at least one intended path from a search user; searching the at least one intended path among the plurality of mental models in a database; generating a search report in a form of a path list, wherein the path list further comprises relevance data correlated with each path; wherein the mental models from the plurality of users is obtained via a mind map, a concept map, a knowledge map, a diagram, a flow, a chart or a category of each of the plurality of users.

### CROSS REFERENCE TO RELATED APPLICATIONS

This application claims the benefit of U.S. Provisional Application No. 61/840,473, filed on Jun. 28, 2013 and entitled “OPERATIONAL STEPS WITH THE INTERFACES AND THE MECHANISMS PROVIDED IN THE SERVICE OF SEARCH SYSTEMS AND METHODS GROUNDED ON STRUCTURAL COGNITIVE CHARACTERISTICS”, the contents of which are incorporated herein.

### BACKGROUND OF THE INVENTION

1. Field of the Invention

The application relates to a method and a computer system for searching an intended path, and more particularly, to a method and a computer system for searching an intended path among user mental models, to derive interested and related information.

2. Description of the Prior Art

Conventionally, the web content cannot clearly presents interested information to a user. For example, when the user visit a blog dedicated to introducing restaurants, the blog may show all information of a particular restaurant in one webpage, and thus the user may find out interested in formation at the end or even nothing interested in the worst case.

Besides, conventional search engines ask users to provide one or more keywords to specify their interests. However, without structural implications, search service systems often return web contents containing user-specified query terms but hardly meeting users' demands as expected. The reason is that users' interests or intentions could not be precisely identified by only a number of separate tokens. In essence, the presentation of a user's intent is to be defined in terms of her/his own interpretation or recognition associated with the query targets. Users interpret and locate their search targets, as an object in cognition, within an established mental schema or cognition, and interpret their understandings of the search targets with pre-conceived ideas in particular schema(s). Such schema revealed in cognition are hierarchical or inter-related, in other words, are structural; and multiple tags that do not bear structural implications cannot represent hierarchies and inter-relationships existing in different concepts in cognition. However, popular modern search engines request information seekers to use multiple keywords without structural implications to specify their query targets, and result in inefficient searching for the information seekers.

Moreover, individuals' ontologies or categorizations for externally modeling a knowledge domain might be different due to diverse background knowledge and different interpretations. Each one may specify the query targets based on her/his individual ontologies or categorizations, which contributes lots of improvements for the search service systems to provide precise responses corresponding to different users' requirements.

Therefore, it is an important issue to provide an innovative approach for searching an intended path from a plurality of paths that are derived from the externalization of users' mental models for all applications.

### SUMMARY OF THE INVENTION

It is therefore an objective of the present invention to provide a method and a computer system for searching an intended path, and more particularly, to a method and a computer system for searching an intended path among user mental models, to derive interested and related information.

A method for searching an intended path among user mental models comprises retrieving a plurality of mental models from a plurality of users; receiving at least one intended path from a search user; searching the at least one intended path among the plurality of mental models in a database; generating a search report in a form of a path list, wherein the path list further comprises relevance data correlated with each path; wherein the mental models from the plurality of users is obtained via a mind map, a concept map, a knowledge map, a diagram, a flow, a chart or a category of each of the plurality of users.

A computer system for searching an intended path among user mental models comprises a central processing unit; a user interface coupled to the central processing unit; and a storage device coupled to the central processing unit for storing a programming code, and the programming code is utilized to instruct the central processing unit for processing a method comprising retrieving a plurality of mental models from a plurality of users; receiving at least one intended path from a search user; searching the at least one intended path among the plurality of mental models in a database; generating a search report in a form of a path list, wherein the path list further comprises relevance data correlated with each path; wherein the mental models from the plurality of users is obtained via a mind map, a concept map, a knowledge map, a diagram, a flow, a chart or a category of each of the plurality of users.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system according to an embodiment of the invention.

FIG. 2 is a flow chart of an intended path searching process according to an embodiment of the invention.

FIG. 3 illustrates a schematic diagram of three mental models according to an embodiment of the invention.

### DETAILED DESCRIPTION

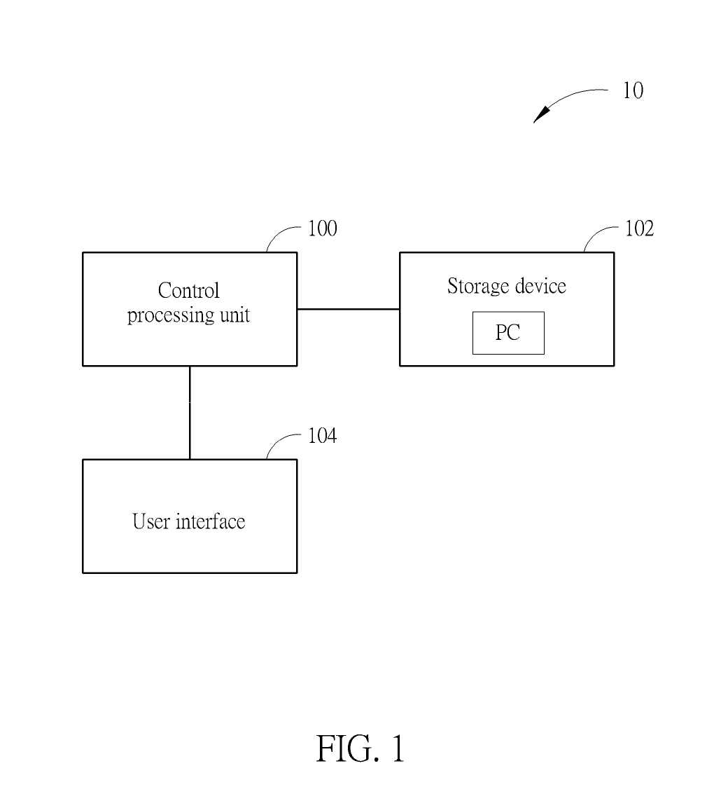

Please refer to FIG. 1, which illustrates a schematic diagram of a computer system 10 according to an embodiment of the invention. The computer system 10 comprises a central processing unit 100, a storage device 102 and a user interface 104. Certainly, the computer system 10 is not limited to comprising the above-mentioned elements/modules/circuits only, i.e. the computer system 10 may further comprises the motherboard, the memory, the hard disk (HD), the south bridge module, the north bridge module, the display panel, etc. In the embodiment, the central processing unit 100 may refer to any form of electronical device including, but not limited to, commodity CPU and GPU, which can execute instructions for realizing the indexing, relevance calculating, and other functionalities required in the embodiment. Moreover, multiple central processing units could be tightly and/or loosely coupled with each other. The central processing unit 100 is coupled to the storage device 102. Likewise, the storage device 102 may refer to any form of device including, but not limited to, magnetic disk, RAID, solid state storage, optical storage, which can accommodate program codes (instructions), users' input data, intermediate operation results, data base, and any other contents required in the embodiment. Similarly, multiple storage devices could be tightly and/or loosely coupled with each other. Also, the storage module 102 stores a programming code PC that is eligible to instruct the central processing unit 100 for processing a intended path searching method. The user interface 104 can be realized as a keyboard, a mouse, a joystick, a touch/display device, a mobile device or any electronic device via a wired/wireless transmission with the central processing unit 100 for providing electronic input signals, such that users can utilize the user interface 104 to create, edit, collect and share the contents of their mental models. Also, the central processing unit 100, the storage module 102 and the user interface 104 could be connected with each other in tightly-coupled (single site) or loosely-coupled (distributed) style, which is not limiting the scope of the invention.

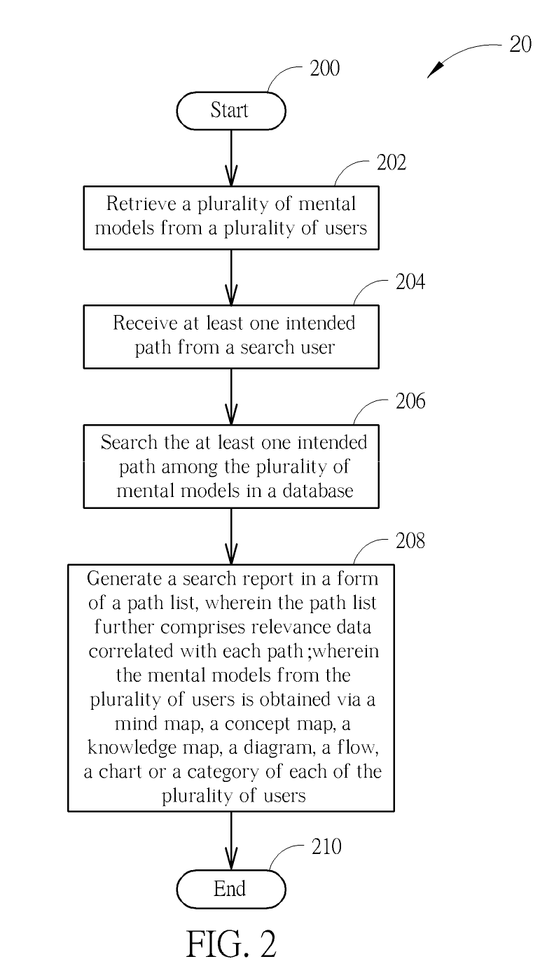

In the embodiment, the method for searching an intended path among user mental models, compiled as the programming code PC, can be directly summarized as an intended path searching process 20, as shown in FIG. 2. The intended path searching process 20 comprises, but not limited to, the following steps:

Step 200: Start.

Step 202: Retrieve a plurality of mental models from a plurality of users.

Step 204: Receive at least one intended path from a search user.

Step 206: Search the at least one intended path among the plurality of mental models in a database.

Step 208: Generate a search report in a form of a path list, wherein the path list further comprises relevance data correlated with each path; wherein the mental models from the plurality of users is obtained via a mind map, a concept map, a knowledge map, a diagram, a flow, a chart or a category of each of the plurality of users.

Step 210: End.

According to the intended path searching process 20, a plurality of computer systems 10 is utilized to retrieve a plurality of mental models from a plurality of users, and then upload the plurality of mental models to a database. Then, a search computer system 10 receives at least one intended path from a search user, and then searches the at least one intended path among the plurality of mental models in the database. Afterwards, the search computer system 10 generates a search report in a form of a path list, wherein the path list further comprises relevance data correlated with each path; wherein the mental models from the plurality of users is obtained via a mind map, a concept map, a knowledge map, a diagram, a flow, a chart or a category of each of the plurality of users. The relevance data correlated by each path comprises information summarized by/with a path, a correlativity of the path, or information eligible for the search user to collect or subscribe. As a result, the search user can search an interest path among the plurality of mental models in the database to derive interested and related information.

In detail, one of the plurality of computer systems 10 provides an interface for a user among the plurality of users to create a mental model comprising a plurality of elements and a plurality of relations thereof in the plurality of paths (i.e. the user's interpretation of the plurality of elements), wherein each of the plurality of elements is obtained via a webpage, a text, an image, a sound, a video or any symbols representing conception, idea or mental content of the user, and each of the plurality of relations is obtained as a hierarchy, a sequence order, a logical dependency or any specified state of affairs among the plurality of elements, which is not limiting the scope of the invention.

After the user creates the mental model, the user can upload the mental model to the database. Therefore, after the plurality of users upload various mental models to the database, the search computer 10 can provide an interface for the search user to freely input and/or define path of his intend by specifying ordered nodes to enter at least one intended path into the search computer 10 and then the search computer 10 search at least one interest path among the plurality of mental models in the database, wherein the interest path comprises an interest sequence of at least one element (e.g. a user can search a path of Food→Chinese, which is different from a conventional dropdown list of Food, Chinese since a path of Chinese→Food will not be shown), and then mental models in the database related to the interest path are presented to the user by a search report in a form of a path list, wherein the path list further comprises relevance data correlated with each path, such that the user can choose any of the presented paths to visit. If the search user considers a path among the path list is useful, the search computer 10 also provides an interface for the search user to collect the path among the path list and optionally the mental model thereof, from the database to the search computer system 10 of the search user, such that the search user can directly look up the path list and optionally the mental model thereof in the search computer system 10. Noticeably, a path in the search report is denoted with a correlativity corresponding to a number of times that the path or the mental model of the path is collected, such that the search user can choose to visit a path with high correlativity. As a result, a path user can search an interest path among mental models in the database to derive interested and related information.

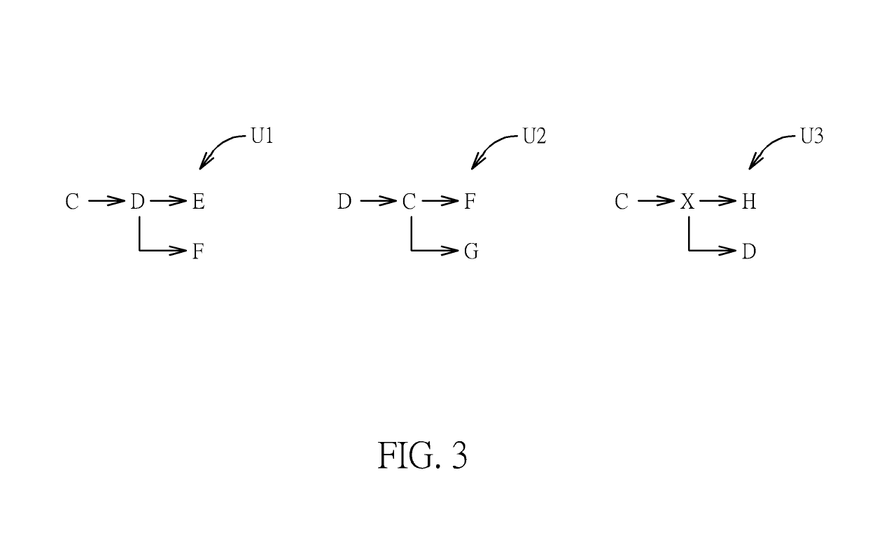

For example, please refer to FIG. 3, which illustrates a schematic diagram of mental models U1-U3 according to an embodiment of the invention. As shown in FIG. 3, the database stores the mental models U1-U3, wherein the mental model U1 comprises paths C→D→E, C→D→F, the mental model U2 comprises paths D→C→F, D→C→G and the mental model U3 comprises paths C→X→H, C→X→D. Under such a situation, when a search user intends to search multiple interest elements among the elements C—H, X, the search user searches an interest path with an interest sequence of at least element (i.e. other than interest elements, the interest sequence also affect a searching result). For example, when the search user searches an interest path C→D, a search result shows the paths C→D→E, C→D→F of the mental model U1 and the path C→X→D of the mental model U3 (the paths C→X→D also meets the interest sequence C→D), but does not show the paths D→C→F, D→C→G of the mental model U2 since the sequence DC of the paths D C→F, D→C→G is different from the interest sequence C→D of the interest path C→D. Besides, when the search result shows each of the paths C→D→E, C→D→F of the mental model U1 and the paths C→X→D of the mental model U3, each correlativity corresponding to a number of times that each of the paths C→D→E, C→D→F of the mental model U1 and the paths C→X→D of the mental model U3 (or the mental model U1 and the mental model U3) is collected is also shown, such that the user can choose the most collected path.

Besides, when the user views the mental model U1, if the user choose the element E, contents of the element E are shown (e.g. all web links under the element E), and if the user choose the element D, contents of the element D and the element F under the element F are shown (e.g. all web links under the element D and the element F which are under the element F).

Besides, when the search user select a path in the search result, the computer system 10 will present all the information categorized under/with the path by any possible user(s), and sorted in the rank of their popularity. For example, if a path A→B of a first mental model comprises a first document, a second document and a third document and a path A→B of a second mental model comprises the second document and the third document, when the search user searches the interest path A→B, the search report may be presented, but not limited to, in one view of path list, if the search user selects the interest path A→B to see all information under the interest path A→B, the search result may further show all information denoted with the number of times which each information is collected (e.g. the first document with 1, the second document with 2 and a third document with 2). In another view, the search report may present the first mental model, the second mental model, and any other mental models comprising the path A→B.

Noticeably, the spirit of the above embodiments is to search an interest path among the plurality of mental models in the database to derive interested and related information. Those skilled in the art can make modifications or alterations accordingly. For example, the computer system 10 can provide an interface for a user to visit a particular element, and display all paths comprising the particular element in the database to the user. That is, when a user visits a webpage or a video with a browser and considers the webpage is useful, the user can request display all paths and the mental models thereof comprising the webpage in the database via an add-on installed in the browser, such that the user can conveniently visit derive mental models with paths comprising the webpage to collect related information, which is not limited to this.

Besides, since interested information can be quickly found out in the mental models with a plurality of paths derived from users by following interpretations of the users, the database storing all mental models derived from all users can be utilized by the computer system 10 or other devices for an artificial intelligence, such that the artificial intelligence can quickly present the result matching the need of a user.

In last, those skilled in the art should adaptively make combinations, modifications and/or alterations on the abovementioned embodiment. The abovementioned steps of the intended path searching process 20 comprising suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), or any mobile communication devices, which is also in the scope of the invention.

In the prior art, the conventional search engines can directly provide interested information by searching the conventional web content.

In comparison, in the above embodiment, a user can search an interest path among mental models in the database to derive interested and related information. Moreover, the artificial intelligence can quickly present the result matching the need of a user by utilizing the mental models in the database.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for searching an intended path among user mental models, the method comprising:
retrieving a plurality of mental models from a plurality of users;
receiving at least one intended path from a search user;
searching the at least one intended path among the plurality of mental models in a database;
generating a search report in a form of a path list, wherein the path list further comprises relevance data correlated with each path;
wherein the mental models from the plurality of users is obtained via a mind map, a concept map, a knowledge map, a diagram, a flow, a chart or a category of each of the plurality of users.

2. The method of claim 1, wherein the step of retrieving the plurality of mental models from the plurality of users comprises:
providing an interface for a user among the plurality of users to create a mental model comprising a plurality of elements and a plurality of relations thereof in the plurality of paths.

3. The method of claim 2, wherein each of the plurality of elements is obtained via a webpage, a text, an image, a sound, a video or any symbols representing concept, conception, idea or other mental contents of the user.

4. The method of claim 2, wherein each of the plurality of relations is obtained as a hierarchy, a sequential order, a logical dependency or other specified states of affairs among the plurality of elements.

5. The method of claim 1, wherein each of the at least one interest path comprises an interest sequence of at least one element.

6. The method of claim 1 further comprising:
providing an interface for the search user to collect a path among the path list.

7. The method of claim 1, wherein a path in the search report is denoted with a correlativity corresponding to a number of times that the path or the mental model of the path is collected.

8. The method of claim 1 further comprising:
providing an interface for the user to visit a particular element; and
providing the interface for displaying all paths comprising the particular element in the database to the user.

9. The method of claim 1 further comprising:
utilizing the plurality of mental models for an artificial intelligence.

10. The method of claim 1, wherein the relevance data correlated by each path comprises information summarized by/with a path, a correlativity of the path, or information eligible for the search user to collect or subscribe.

11. The method of claim 1, wherein the step of receiving the at least one intended path from the search user comprises:
providing an interface for the search user to freely input and/or define path of his intend by specifying ordered nodes.

12. A computer system for searching an intended path among user mental models, the computer system comprising:
a central processing unit;
a user interface coupled to the central processing unit; and
a storage device coupled to the central processing unit for storing a programming code, and the programming code is utilized to instruct the central processing unit for processing a method comprising:
retrieving a plurality of mental models from a plurality of users;
receiving at least one intended path from a search user;
searching the at least one intended path among the plurality of mental models in a database;
generating a search report in a form of a path list, wherein the path list further comprises relevance data correlated with each path;
wherein the mental models from the plurality of users is obtained via a mind map, a concept map, a knowledge map, a diagram, a flow, a chart or a category of each of the plurality of users.

13. The computer system of claim 12, wherein the step of retrieving the plurality of mental models from the plurality of users comprises:
providing an interface for a user among the plurality of users to create a mental model comprising a plurality of elements and a plurality of relations thereof in the plurality of paths.

14. The computer system of claim 13, wherein each of the plurality of elements is obtained via a webpage, a text, an image, a sound, a video or any symbols representing concept, conception, idea or other mental contents of the user.

15. The computer system of claim 13, wherein each of the plurality of relations is obtained as a hierarchy, a sequential order, a logical dependency or other specified states of affairs among the plurality of elements.

16. The computer system of claim 12, wherein each of the at least one interest path comprises an interest sequence of at least one element.

17. The computer system of claim 12, wherein the method further comprises:
providing an interface for the search user to collect a path among the path list.

18. The computer system of claim 12, wherein a path in the search report is denoted with a correlativity corresponding to a number of times that the path or the mental model of the path is collected.

19. The computer system of claim 12, wherein the method further comprises:
providing an interface for the user to visit a particular element; and
providing the interface for displaying all paths comprising the particular element in the database to the user.

20. The computer system of claim 12, wherein the method further comprising:
utilizing the plurality of mental models for an artificial intelligence.

21. The computer system of claim 12, wherein the relevance data correlated by each path comprises information summarized by/with a path, a correlativity of the path, or information eligible for the search user to collect or subscribe.

22. The computer system of claim 12, wherein the step of receiving the at least one intended path from the search user comprises:
providing an interface for the search user to freely input and/or define path of his intend by specifying ordered nodes.
